(19) United States
(12) Patent Application Publication
(10) Pub. No.: US 2011/0078510 A1
(43) Pub. Date: Mar. 31, 2011

(54) Computer Software and Hardware Evaluation System and Device

(75) Inventors: Daniel Beveridge, Jersey City, NJ (US); John Premus, Sandy Hook, CT (US); Lucian Lipinsky de Orlov, Goldens Bridge, NY (US)

(73) Assignee: VIRTERA, Shelton, CT (US)

(21) Appl. No.: 12/570,951

(22) Filed: Sep. 30, 2009

(51) Int. Cl. G06F 11/36; G06N 5/02; G06F 9/455; G06F 11/00

(52) U.S. Cl. 714/38.1; 706/47; 718/1; 714/E11.207

(57) ABSTRACT

The present disclosure generally relates to systems and devices that enable computer software or hardware systems to be evaluated. In an embodiment, an evaluation processing device can receive a set of needs or requirements for a computer software or hardware system from a user or organization. The evaluation processing device may determine software or hardware configurations that may be suitable for the user based on the set of needs, and configure one or more evaluation devices with software of hardware based on the determination. The evaluation processing device can allow the user to evaluate the software of hardware configurations by utilizing the one or more configured evaluation devices. Additionally, the integration device can receive information related to the evaluation from the one or more evaluation devices and generate a report based on the information.

### BACKGROUND

1. Field

The present disclosure generally relates to evaluation technologies. More specifically, the present disclosure relates to systems and devices which can allow examination of a variety of software and hardware systems in a hosted proof of concept environment.

2. Discussion of the Related Technology

Generally described, computer software refers to the role that computer programs play in a computer system. Computer hardware generally refers to the physical components of the computer system. Demonstration and evaluation of computer software or hardware, and other devices (e.g. routers, hubs, firewalls, etc.) may include identifying requirements to be addressed by the computer software or hardware being deployed (e.g. performance, functionality, reliability, cost, etc.); identifying the software or hardware, ordering the software or hardware; integrating and configuring the software or hardware; and testing the software or hardware. Often, this process may be repeated for each potential configuration of software or hardware to allow comparisons to be made.

Unfortunately, this process can be expensive, inconvenient, and time consuming. In addition, this process can be especially difficult for hardware and software users that do not possess the expertise needed to make an informed decision in one or more of the steps described above. Accordingly, selecting and deploying software and hardware systems for information technology professionals and other users can be difficult because of these and other shortcomings.

### SUMMARY

The present disclosure generally relates to a computer software and/or hardware evaluation system and device. In an embodiment, a system that provides for hosting a proof of concept of various platforms of hardware and/or software is disclosed. The system may allow a user to utilize or evaluate various hardware devices and/or software components in a dynamic, virtualized environment, for example. The system may also allow users to test or screen a variety of scenarios or configurations of hardware or software products in order to allow the user to determine in real time or near real time the feasibility of various configurations.

This can advantageously allow the user to avoid the risk associated with spending time and money on an unknown and untested configuration of software and/or hardware that may be not be suited to the user's needs (e.g. response time, reliability, functionality, availability, scalability, etc.). Thus, users of the system may determine the feasibility of a particular configuration or selection of hardware or software components and/or determine which configurations are capable of satisfying their information technology needs quickly. Embodiments of the present disclosure may be particularly useful for rapidly designing a particular system of hardware and software for a user, based on a set of requirements.

In an embodiment, an evaluation processing device is provided. The evaluation processing device can include a computer memory that may be configured to store configuration information related to one or more evaluation devices that allow one or more computer software products and/or hardware resources to be evaluated. The evaluation processing device may further include a processor that may be configured to compare a request to evaluate the one or more computer software products from a user with the configuration information, establish a connection to the one or more evaluation devices using a network interface based on the comparison, and allow the user to evaluate the one or more computer software products and/or hardware resources over the connection. The network interface can be configured to receive a set of needs from the user, and the processor can be further configured to determine suitable software products for the user based on the set of needs. The processor may be further configured to provision the one or more evaluation devices with the suitable software products. In addition, the memory may be further configured to store a set of rules for possible configurations of the one or more computer software products, and the processor may be configured to set up the one or more evaluation devices based on the set of rules.

In exemplary embodiments, a computer-implemented method is provided. The method may include receiving information to register an organization to evaluate at least one product; setting up one or more evaluation devices with the at least one product based on the organization information; and enabling the organization to evaluate the at least one product on the one or more evaluation devices. In addition, the method may include registering a user associated with the organization. The method may also include setting up the one or more evaluation devices with the at least one product based on the user information. The organization information can include a set of requirements for the organization, for example.

In some embodiments, a computer readable medium having stored thereon computer executable components is provided. The medium may include a rules engine that may be configured to group a plurality of products into interoperable sets; and an evaluation processing engine that may be configured to receive a set of needs of a user, match the needs of the user with the interoperable sets of products, and provision one or more evaluation devices with at least one interoperable set of products based on the matching. The set of needs of the user may be based on one or more responses to questions by the user. In addition, the evaluation processing engine can be further configured to provision the one or more evaluation devices based on permissions of the user. The rules engine may group the plurality of products into interoperable sets based on a set of rules that determine which products are interoperable with one another.

In another embodiment, a computer-implemented method is provided. The method may include installing a first hypervisor on an evaluation device; and installing a set of one or more hypervisors on top of the first hypervisor in order to allow a plurality of users to evaluate one or more software products. In some embodiments, each of the set of hypervisors may be configured for a different one of the plurality of users. Accordingly, improved reliability by providing security isolation or sandboxing from other users in proof of concept environments can be provided, for example.

Advantages and features of the disclosure in part may become apparent in the description that follows and in part may become apparent to those having ordinary skill in the art upon examination of the following or may be learned from practice of the disclosure. The advantages and features of embodiments of the present disclosure may be realized and attained by the structures and processes described in the written description, the claims, and in the appended drawings.

It is to be understood that both the foregoing general description and the following detailed description are exemplary and explanatory and should not be construed as limiting the scope of the claims.

### BRIEF DESCRIPTION OF THE DRAWINGS

The accompanying drawings are included to provide a further understanding of the disclosure, and are incorporated herein and constitute a part of this application. The drawings together with the description serve to explain exemplary embodiments of the present disclosure. In the drawings:

FIGS. 1A-C illustrate block diagrams of exemplary systems capable of evaluating computer software or hardware, according to embodiments of the disclosure;

FIG. 2 illustrates a flow diagram of evaluation processing performed by exemplary components of the systems of FIGS. 1A-C;

FIGS. 3-5 illustrate routines and actions performed by exemplary components of the devices of FIGS. 1A-C, according to an embodiment of the disclosure;

FIG. 6 illustrate routines and actions performed by exemplary components of the devices of FIGS. 1A-C to configure one or more evaluation devices, according to an embodiment of the disclosure; and

FIG. 7 illustrates an exemplary configuration of an evaluation device set up by exemplary components of an evaluation processing device, according to embodiments of the disclosure.

### DETAILED DESCRIPTION OF THE ILLUSTRATED EMBODIMENTS

The present disclosure generally relates to methods and systems for installing, configuring, and operating computer software from a library of potential components based on technical and/or business requirements in a virtual environment. In some embodiments, a system can provide a hosted proof of concept and/or provide a platform to test various configurations of hardware and software, for example, in order to determine its suitability for a client's technology requirements or parameters. A front-end interface or application may also be provided, through which a client can test permutations and combinations of hardware, software, and/or firmware in a virtual environment before making significant capital expenditures to purchase a technology solution (software, hardware, and/or firmware components, for example). Accordingly, users may quickly install, test, evaluate, and/or measure the capabilities and performance of desktop virtualization technologies, among others, for example.

In some embodiments, a system may be used to evaluate components, such as software or hardware, from various manufacturers. A front-end administration or management interface, may be provided that can present business and/or technical questions in order to determine which components to integrate in order to provide an evaluation prototype or system for a client. In an embodiment, once the components are determined, the system may install, configure and present to a client or user an integrated system that may include one or more software or hardware products from one or more product manufacturers. Alternatively, an administrator may preselect a configuration or scenario suitable for a particular client prior to evaluation of the configuration or scenario in place of an automated configuration or scenario for evaluation.

Reference will now be made in detail to the specific embodiments of the present disclosure, examples of which are illustrated in the accompanying drawings. Wherever possible, the same reference numbers will be used throughout the drawings to refer to the same or like parts.

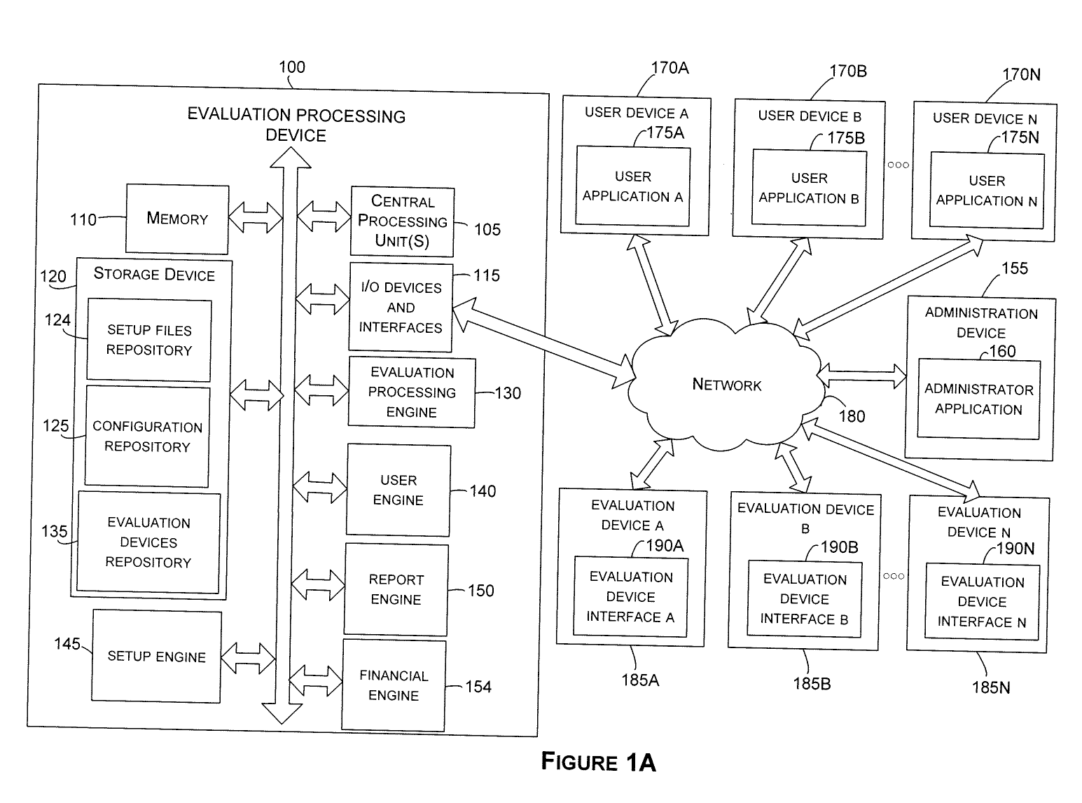

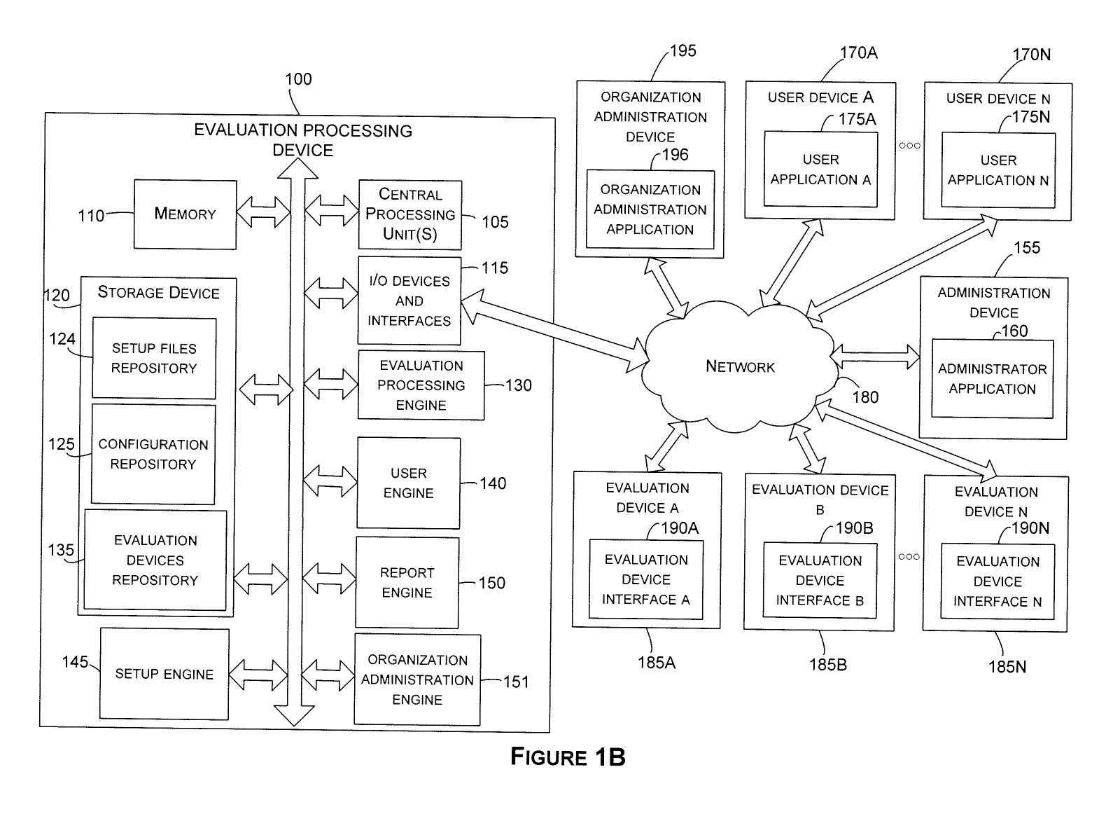

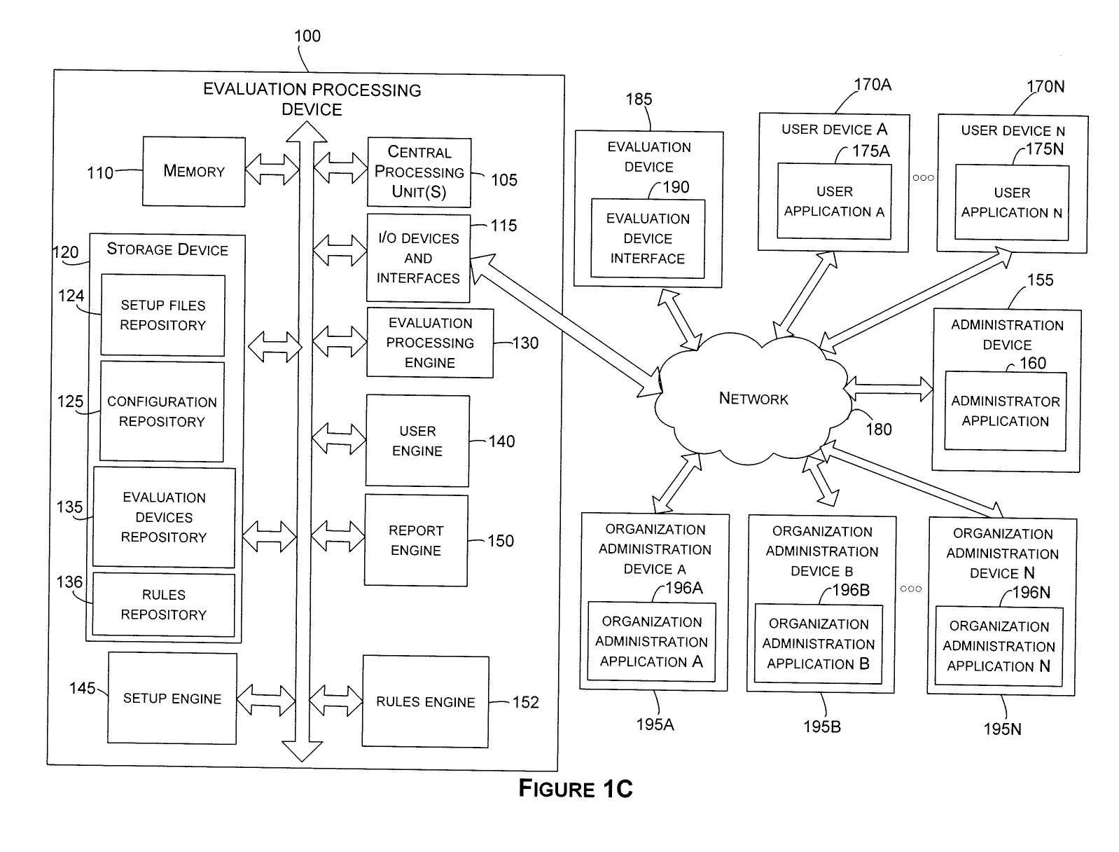

FIG. 1A illustrates a block diagram of an exemplary system capable of providing an evaluation platform to test various configurations of hardware and/or software. As shown, an evaluation processing device 100 communicates with administration device 155, user devices 170A, 170B, and 170N (representative of any number of user devices), evaluation devices 190A, 1908, 190N (representative of any number of evaluation devices), and/or other devices over a network 180. Communication within the system may take place over network 180 using sockets, ports, and other mechanisms known in the art. The communication may also be via wires, wireless technologies, cables, or other digital or analog techniques and devices to perform those techniques over a local area network (LAN), wide area network (WAN), or the interne, for example. Evaluation processing device 100, administration device 155, user devices 170A-N, evaluation devices 185A-N, and/or other devices can be a computing system, such as one or more computer servers or a peer-to-peer architecture. Of note, evaluation processing device 100, administration device 155, user devices 170A-N, evaluation devices 185A-N, and/or other devices may reside on physically separate machines, such as computers, or be on the same machine. In addition, the illustrated system and devices may be configured to operate in local, remote, or cloud computing environments.

Evaluation processing device 100, and other devices shown, can include one or more central processing units (CPUs) 105, a memory 110, such as random access memory (RAM), to store information temporarily or permanently, one or more input/output (I/O) devices and interfaces 115, such as a network interface or card, keyboard, and the like to receive or transmit data. Evaluation processing device 100 may further comprise a storage device 120, such as one or more hard drives. The storage device 120 includes one or more data repositories having a variety of structured or unstructured content, such as file systems or databases. Components of evaluation processing device 100 can be interconnected using a standards based bus system, such as Peripheral Component Interconnect (PCI), for example. Evaluation processing device 100 may include various operating systems, web servers, hardware resources, and be on different network domains. The operating systems and other software, such as evaluation processing engine 130, may manage the various hardware resources, including evaluation devices 185A-N, and provide a graphical user interface (GUI) through a web server, for example.

As shown, evaluation processing device 100 and other devices shown, such as administration device 155, user devices 170A-N, and/or evaluation devices 185A-N may include one or more engines or applications. In general, the word engine (used interchangeably with the word application or module), as used herein, refers to logic embodied in hardware or software instructions, which can be written in a programming language, such as Java™, PHP, Perl, PHP, HTML, CSS, and/or JavaScript, for example. A software engine or application can be compiled into executable programs or written in interpreted programming languages. Software engines or applications may be callable from other engines or themselves. Generally, the engines or applications described herein refer to logical modules that may be merged with other engines or applications or divided into sub-engines despite their physical organization. The engines or applications can be stored in any type of computer readable medium or computer storage device and be executed by one or more general purpose computers. In addition, the methods and processes disclosed herein can alternatively be embodied in one or more engines, applications, or specialized computer hardware.

Evaluation processing device 100 may include an evaluation processing engine 130, user engine 140, setup engine 145, and report engine 150. User engine 140 and/or report engine 150 can include an application running in a web environment, electronic mail server, and/or native application that interfaces with a user application 175A-N, such as a web browser, electronic mail client, or native application that runs on user devices 170A-N. User engine 140 and user application 175A-N may determine the hardware or software needs of a user by asking the user a series of questions and/or allow the user to directly enter information, such as business and technical requirements related to performance, scalability, reliability, etc. In some embodiments, user engine 140 and user application 175A-N may be configured to ask questions or allow a user to enter information that determines which product, feature, specific configuration and/or version to use. In addition, various parameters, such as those related to hardware resources, may be specified by a user that related to the number of switch ports, bandwidth requirements or other networking needs, memory, CPUs, power consumption, disk space, etc. In addition, an organization administrator may interface with evaluation processing 100 to also specify such information as will be further described with respect to FIGS. 1B-C.

Following the partial or complete determination of the configuration to create for a user, the system may install the determined components, configure and set parameters or other variables, and/or make the solution ready for use. For example, evaluation processing engine 130 may interface with the various repositories shown in order to extract information regarding evaluation devices 185A-N, for example. Setup engine 145 may then configure the one or more evaluation devices 185A-N using the various repositories in accordance with the needs of a user in order to allow the user to experiment with various configurations of hardware and/or software. This can advantageously allow users to evaluate their hardware or software needs, and various components rapidly, such as in real time or near real time. Additionally, the automatic installation and provisioning of the evaluation devices 185A-N can save user's the time of communicating with different manufacturers and/or setting up the evaluation environment manually.

Report engine 150 may be used to provide various metrics or analysis of the feasibility of the particular configurations based on the user's trial or use of the evaluation devices 185A-N provisioned with the various configurations. Reports can provide collected metrics based on log files, for example, that track technical performance and user access. The evaluation processing device 100 may further include a financial engine 154 which can model the costs of particular hardware and/or software configurations in view of the benefit provided to a user and/or the user's needs, in order to facilitate the user's evaluation of the configured proposed solutions to the user's information technology needs. Report engine 150 and financial engine 154 can advantageously be used to provide a comparison (e.g. side-by-side) of competing configurations or technologies (e.g. software or hardware products) from the same or different manufacturers.

The storage device 130 may include a setup files repository 124, configuration repository 125, and an evaluation devices repository 135. Generally, these repositories may be configured to store information related to one or more evaluation devices 185A-N in order allow various computer hardware (e.g. appliances, routers, servers, etc.) and computer software products to be demonstrated to a user. Evaluation devices 185A-N can include one or more virtual machines or virtualization platforms, such as machines whose processing capability is harnessed to improve efficiency by making use of hypervisors, for example. The repositories may be configured (e.g. deleted, updated, modified) by a system administrator using an administrator application 160 that communicates with evaluation processing engine 130 that is in communication with the various repositories.

Generally, setup files repository 124 stores information, such as installation and source files, and other related program information. The set up files repository 124 can include one or more virtual machine templates or files to configure evaluation devices 185A-N with a particular configuration for one or more users. In an embodiment, setup files repository 124 can include core virtualization technologies, such as various hypervisor management platforms (e.g. Citrix Xen Server™, Microsoft Hyper-V™, VMware VI3™) and desktop virtualization technologies, such as brokers (e.g. Citrix XenDesktop™, VWorkspace™, VMware View™, etc.), image management platforms, storage platforms (e.g. Citrix Provisioning Server™, FAT™, VMware View Composer™, etc.), profile managers (e.g. AppSense Environment Manager™), and/or application virtualization platforms (e.g. Citrix XenApp RADE™, Microsoft App-V™, VMware Think App™, etc.).

Evaluation devices repository 125 may store information related to the evaluations devices 190A-N which may be available for provisioning to support and run the evaluation of one or more configurations. In particular, evaluation devices repository 125 can include a list, including inventory or status, of one or evaluation devices 185A-N and configurations of the evaluation devices 185A-N, including available hardware (e.g. disk size, RAM size, number of CPUs, network configuration, etc.) or software capabilities (e.g. operating systems, installed applications, such as Microsoft Office™, Adobe Reader™, Mozilla Firefox™ Java™, etc.). For example, evaluation devices repository 125 may include information regarding the operating systems (e.g. Microsoft Windows™, Linux™, etc.) installed on an evaluation device 190A-N that may run on or more hypervisors, types of virtualization software (e.g. Citrix™, VMware™, etc.), and the like. In addition, evaluation devices repository 125 may also include a list of the functions of the evaluation devices 185A-N, such as domain controller, file server, SQL server, desktop manager, router, firewall, licensing server, etc.

Configuration repository 125 generally stores configuration information, which may include administrator defined configurations of software components or configurations. These configurations may also be previously created automatically by the evaluation processing device 100 in accordance with the user-provided scenario information (for example, using answers to questions) by evaluation processing engine 130, for example. In addition, configuration repository 125 can include entitlement information as to the different labs or configuration solutions set up for different users, such as which evaluation devices 185A-N users have access to. In some embodiments, a configuration can include logical components of a desktop virtualization solution, such as hypervisors, connection brokers, application virtualization technologies, user profile managers, storage platforms, etc. A configuration can be created and mapped to create a lab or solution on one or more evaluation devices 185A-N for particular users, by an administrator using administrator application 160 or automatically by evaluation processing engine 130 and setup engine 145, for example. In addition, a particular configuration or aspects of a configuration may be deleted or modified to change software or hardware needs or to add new users for a particular client. Of note, multiple configurations can be bound to the same physical or logical devices, such as evaluation devices 185A-N, through the use of virtualization technologies, such as hypervisors, etc. Thus, multiple clients or users may share desktop pools through their configured labs (e.g. a set of one or more proposed solutions or configurations to a user's hardware or software needs).

In some embodiments, the various engines of evaluation processing device 100, such as evaluation processing engine 130 and setup engine 145 can use the repositories to provision and set up evaluations devices 190A-N. Accordingly, when a user connects from a user device 170A-N using user application 175A-B, the user engine 140 may send the user application 175A-N a series of questions regarding software or hardware the user may desire to evaluate or ask a series of questions to ascertain a set of hardware or software components that may potentially meet the user's needs. Based on the user's response, administrator application 160 or setup engine 145, may configure the one or more evaluation devices 185A-N.

For example, administrator application 160 may execute setup engine 140 and/or other engines on evaluation processing device 100 in order to utilize use evaluation devices repository 135 and configuration repository 125 to select one or more evaluation devices 185A-N to provision, based on the user's needs. Setup files repository 124 may also be used to then configure evaluation devices 185A-N based on the user's needs. Additionally, information related to a user's particular configuration or lab may be stored in configuration repository 125 after provisioning evaluation devices 185A-N, for example. Alternatively, setup engine 140 acting alone or together with other engines of evaluation processing device 100 may perform a similar process.

Subsequently, when a user connects, a provisioning layer, such as user engine 140, may query the configuration repository 125 to determine which evaluation devices 190A-B are provisioned for a particular user and connect the user to the evaluation devices 185A-N using evaluation device interfaces 190A-N, either directly or through evaluation processing device 100. In some embodiments, the evaluation device interfaces 190A-N may include a virtualization platform specific interface, such as an interface to VMware™, Citrix™, etc., or a standard API that provides an intermediate layer in order to facilitate communication among the different virtualization platforms installed on the evaluation devices 185A-N. Evaluation device interfaces 190A-N can allow commands or instructions understood by the installed components to be received, translated, and/or executed by evaluation devices 185A-N during configuration and/or evaluation of a configuration by a user.

Report engine 150 generally provides one or more reports to user devices 170A-N or other devices. In some embodiments, the reports may include levels of hardware or software utilization for a particular configuration, e.g. CPU, memory, storage, power, and/or network use, in order to allow a client to evaluate the feasibility of particular configuration(s). The reports, which can be presented in graph format, may be presented to a user via user application 175A-N. In an embodiment, report engine 150 may query or monitor evaluation devices 185A-N (e.g. extract information from log files) in order to obtain performance data when a particular configuration is being evaluated and compile such information in a format suitable for reporting. Report engine 150 can communicate with evaluation devices interfaces 185A-N to acquire such data.

An administrator may control user access to the evaluation processing device 100 using administration device 155, for example. Administration device 155 may be located separately from the evaluation processing device 100, user devices 170A-N, and/or evaluation devices 190A-N. Using administration device 155, the administrator may, for example, limit the scenarios which a certain user may evaluate, or may even limit a certain user to a single configuration to be evaluated using administrator application 160, for example. The administrator may have direct access to the evaluation processing device 100, or may provide administration via network 180 using administration device 155 to manage the interface shown to users at user devices 170A-N or to control the available configurations at the evaluation processing device 100. In exemplary embodiments, administrator application 160 can be used for management of the evaluation environment. For example, administrator application 160 can be used to set security permissions and/or restrictions for the users. In addition, administrator application 160 can provide reports which may include the installed system components and/or their related technical performance, financial information on the monetary impact of the selected and configured solutions, and/or comparisons to other solution or labs to the administrator. Administrator application 160 may query report engine 150 and financial engine 154 to collect such information.

FIG. 1B illustrates a block diagram of an exemplary system capable of evaluating computer software or hardware which is configured for use by an organization. An organization may include an enterprise, for example, that has one or more users that access evaluation processing device 100 via user devices 170A-N. In addition, the organization may utilize an organization administration device 195 that includes an organization administration application 196 to access evaluation processing device 100 or evaluation devices 100A-N. The organization administration device 195 can allow an organizational administrator to grant permission to users of the organization to access the system and evaluate hardware and software labs configured for the organization. Advantageously, this can allow an organization to quickly determine its information technology needs and rapidly prototype a solution.

For example, organization administration application 196 may allow a single user to evaluate a predetermined configuration while allowing a different user to evaluate a different predetermined configuration (or the same) to determine its reliability, performance, scalability, functionality, availability, etc. Evaluation processing device 100 may also include an organization administration engine 151 to interface and communicate with organization administration device 195. Of note, organization administration application 196 can be configured to communicate with other engines of evaluation processing device 100, such as evaluation processing engine 130, user engine 140, report engine 150, or financial engine 154 in order to determine the feasibility of the various configurations. Using organization administration application 196 or administrator application 160, for example, various user environments and credentials can be configured via evaluation processing engine 130. In addition, logs residing on evaluation processing device 100 or evaluation devices 185A-N, for example, may be viewed by organization administration application 196 or administrator application 160 in order to track users of an organization that access the system, for example.

FIG. 1C illustrates a block diagram of an exemplary system capable of evaluating computer software or hardware which is configured for use by a plurality of organizations. In the illustrated embodiments, multiple organization administrators (for example, from different organizations) can access and use the evaluation processing device 100 and evaluation device 190A-N for their organizations. An organization may include an enterprise, for example, that has one or more users that access evaluation processing device 100 via user devices 170A-N. As shown, a plurality of organization administration devices 195A, 195B, 195N (representative of any number of organization administration devices) can include organization administration applications 196A-N. An organization administration engine 151 of evaluation processing device 100 can thus be configured to communicate with organization administration applications 195A-N to allow multiple organizations to demonstrate a proof of concept of computer software and hardware configurations for their organizations, for example.

As further shown in FIG. 1C, evaluation processing device 100 includes a rules engine 152. Generally, rules engine 152 can be executed when evaluation processing device 100 receives information, such as potential software or hardware selections to provision on evaluation devices 185A-N. Rules engine 152 may receive this information from user engine 140 when a user application 175A-N or an organization administration application 195A-N selects particular hardware or software configurations to evaluate. In response to receiving the information, rules engine 152 may match or correlate the information against rules repository 136 to determine whether the various software or hardware selections are compatible with one another. Generally, rules repository 136 includes a set of rules for possible configurations of the one or more computer software or hardware products. The rules may be in the form of logical if statements and/or may be pre-configured or generated in a dynamic rule based fashion. For example, a rule may specify which hypervisor management platforms, brokers, image management platforms, profile managers, and/or application virtualization platforms can be used together. Rules engine 152 and rules repository 136 can be used by setup engine 145 and evaluation processing engine 130 to create virtual machine templates, such as those in setup files repository 124, in order to quickly configure the evaluation devices 185A-N based on the rules, for example.

Of note, because evaluation devices 185A-N may provide a platform-independent interface, such as evaluation device interfaces 190A-N, the system may allow software and/or hardware which may not be conventionally compatible or interoperable with one another to interface or integrate with each other. The non-interoperable software may include software and/or hardware that may be of different platforms, types, versions, made by different manufacturers, or partially compatible with each other for one or more features (e.g., partially interoperable). The level of integration provided by evaluation device interfaces 190A-N can be full or partial amongst the various hardware or software components in a configuration.

In other embodiments, the systems of FIGS. 1A-C can also be configured for the quick installation, testing, evaluation, and/or measurement of server virtualization, remote office branch office (ROBO), wide area network (WAN) optimization, or data center automation. Alternatively, embodiments of the of the systems of FIGS. 1A-C can also be used in a variety of environments, such as automated disaster recovery (DR), business continuity (BC), application virtualization (e.g. legacy, office productivity, new development), application development or testing, and/or quality insurance (e.g. in-house or off-shore).

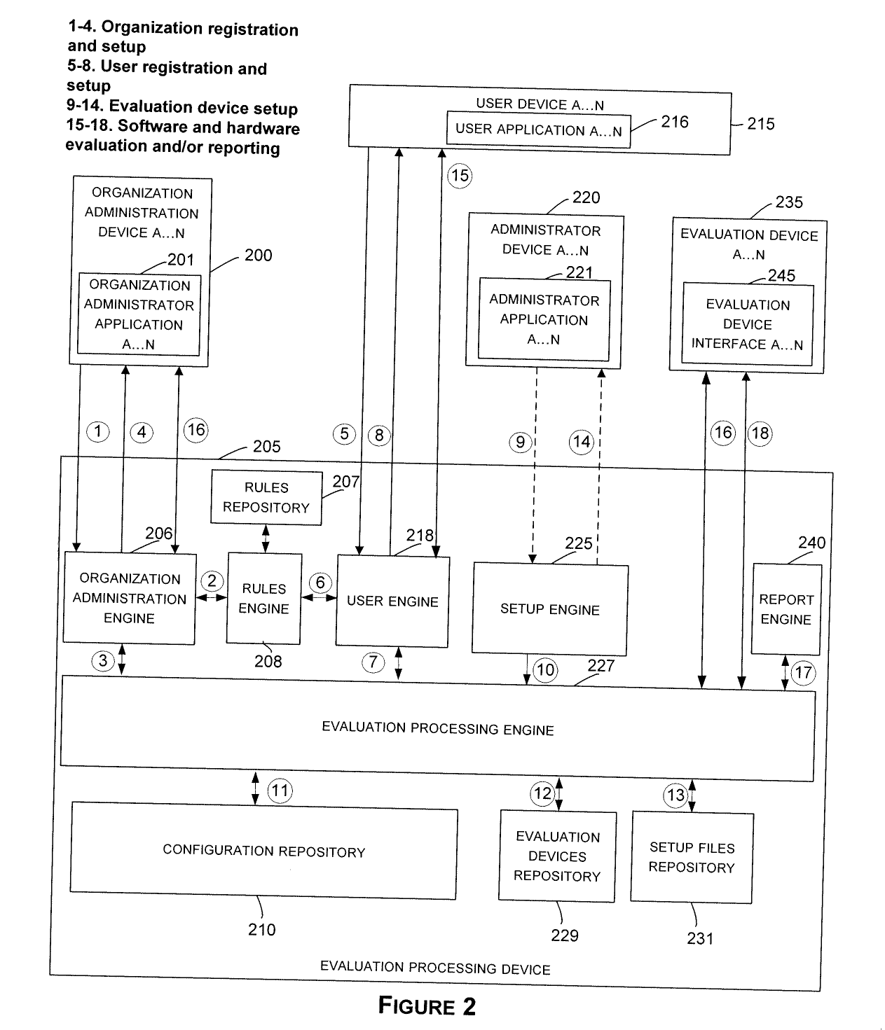

FIG. 2 illustrates a flow diagram of evaluation processing performed by exemplary components of the systems of FIGS. 1A-C. In some embodiments, this routine can be performed by components of evaluation processing device 100, administration device 155, user devices 170A-N, evaluation devices 185A-N, and/or organization administration device 195. Depending on the embodiment, the method of FIG. 2 may include fewer or additional blocks and blocks may be performed in an order that may be different than illustrated.

Beginning in step 1, an organization administration device 200, which has installed thereon an organization administrator application 201, accesses the evaluation processing device via an organization administration engine 206 in order to register and set up an organization in the evaluation system. Organization administration engine 206 controls the administrative functions that can be performed by an organization administrator, such as, the ability to grant access to an organization or a user of an organization access to the evaluation processing device 205. In addition, organization administration engine 206 allows the organization administrator to select factors, such as functionality (software and/or hardware), reliability, performance (e.g. bandwidth, memory, etc.), and others for the organizational configuration(s). Continuing to step 2, organization administration engine 206 may further access a rules engine 208 to enable or assist it in determining which rules are applicable to a particular organization, such as, which software scenarios a particular organization may be allowed to evaluate or test. In some embodiments, more than one organization administration device 200A-N may access the evaluation processing device 205 via the organization administration engine 206.

In alternative embodiments, an artificial intelligence design may also be used to determine which rules apply based on information about the user, the organization, or other factors as would be appreciated in a particular situation. Logic in the rules engine 208 may triage the rules applicable to a particular user, organization, or scenario. For example, the rules engine 208 may validate rules to be applied in a particular situation. In the illustrated embodiments, the rules engine 208 accesses a rules repository 207 to access stored data related to rules to be applied under a given set of circumstances.

Moving to step 3, organization administrator application 201 may access an evaluation processing engine 227 via the organization administration engine 206, according to the applicable rules from the rules engine 208, for example. Continuing to step 4, the organization administration engine 206 communicates between the rules engine 208 and the organization administration device 200 to provide a rules-based interface based on the rules via the rules engine 208.

Continuing to step 5, an example of user registration and setup is illustrated. As shown, a user device 215 including a user application 216 accesses the evaluation processing device via a user engine 218. The user engine 218 verifies that the user is authorized to access the system and/or registers the user according to the rules applicable to a particular user or organization. Moving to step 6, the user engine 218 accesses the rules engine 208 to determine whether a particular configuration or selection of hardware or software components and/or other requirements (memory, bandwidth, or other needs) for a user of the organization is valid. Continuing to step 7, user engine 218 retrieves and applies the rules by which the user device 215 may access the evaluation processing engine 227 and evaluation devices 235A-N via the user engine 218. In step 8, the user application 215 completes registration and setup with the evaluation processing engine 227. Of note, one or more of the illustrated repositories or others (not shown) may store particular configurations, functional or technical requirements, and the like which may be selected by the organization administrator via organization administrator application 201 or a user via user application 216.

Moving to block 9, separately an administrator, such as a consultant or technical practitioner, can set up or configure the evaluation processing devices 235A-N. An administrator device 220 may include an administrator application 221 to allow such an administrator to access the evaluation processing device 205. The administrator can control a setup engine 225, and therefore can set up, configure, and manage evaluation devices 235A-N, rules, user profiles, software configurations, evaluation scenarios, system availability, network profiles, repository contents, etc. via evaluation processing engine 227. Alternatively, setup engine 225 may run automatically, without any intervention by an administrator device 220 or administrator application 221 (e.g. without the presence of illustrated steps 9 and 14). Continuing to step 10, setup engine 225 can be connected to the evaluation processing engine 227 and provide such setup information to the evaluation processing engine 227.

Moving to steps 11 and 12, evaluation processing engine 227 queries and/or loads contents of the configuration repository 210 and evaluation devices repository 229. Based on one or more factors, such as the current provisioning setup of evaluation devices 235A-N and configuration information (e.g. user or organizational needs) provided by the user application 216 and/or organization administrator application 201, evaluation processing engine 227 provisions the evaluation devices 235A-N. Moving to block 13, evaluation processing engine 225 accesses the necessary setup files in setup files repository 231 and installs them on evaluation devices 235A-N in accordance with the needs of the organization and users. The configurations or orchestration for various evaluation devices 235A-N may then be stored into configuration repository 210 for later retrieval, such as during evaluation of software or hardware products, by the user. In block 14, setup of the evaluation devices 235A-N by the administrator application 221 or setup engine 225 is completed.

Continuing to step 15, a user of the evaluation system can determine whether the software and hardware provisioned on the evaluation devices 235A-N meets their needs and/or that of the organization. As shown, user application 216 can be used to access the user engine 218 of evaluation processing device 205. Continuing to steps 16-18, user application 216 can use using evaluation processing engine 227 to then access evaluation devices 235A-N. Evaluation processing engine 227 can be configured to communicate with evaluation device interfaces 245A-N in order to allow the user to access and use evaluation devices 235A-N to determine the feasibility of a particular configuration or information technology solution. With respect to step 17 in particular, various reports as described with reference to FIGS. 1A-C may be generated by report engine 240 and returned to user application 216, organization administrator application 201, or administrator application 221.

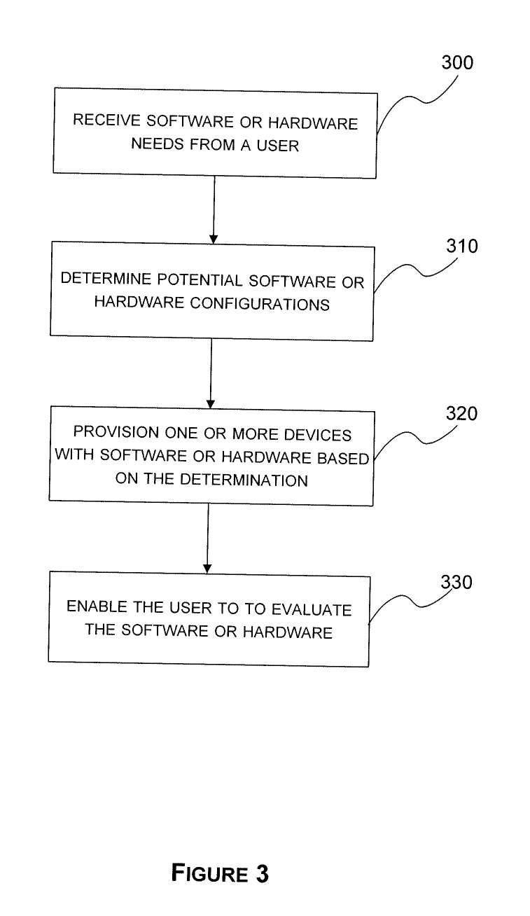

FIG. 3 illustrates routines and actions performed by exemplary components of a system for evaluating one or more software and/or hardware solutions. In some embodiments, this routine can be performed by components of evaluation processing device 100, administration device 155, user devices 170A-N, evaluation devices 185A-N, and/or organization administration device 195. Depending on the embodiment, the method of FIG. 3 may include fewer or additional blocks and blocks may be performed in an order that may be different than illustrated.

Beginning in block 300, a computer software and/or hardware evaluation system or device (e.g. evaluation processing device 100) may receive information related to software and/or hardware needs of a user. The information may be related to business requirements, such as response time, memory needs, bandwidth, and/or other parameters related to performance or reliability. Alternatively, the information may relate to functional needs, such as application needs, or those described with respect to other Figures herein. The user may be a business, for example, that desires to evaluate how various software or hardware configurations will perform on site once installed before making a capital expenditure on particular software and hardware configurations.

Moving to block 310, evaluation processing device 100 may then determine, based on information received from the user, one or more potential software and/or hardware configurations applicable to the needs of the user. Continuing to block 320, evaluation processing device 100 can provision one or more evaluation devices, which may be virtualized, to emulate the software and/or hardware based on the prior determination of potential configurations. Moving to block 330, the user can then be enabled to evaluate the software or hardware configuration(s) using the system.

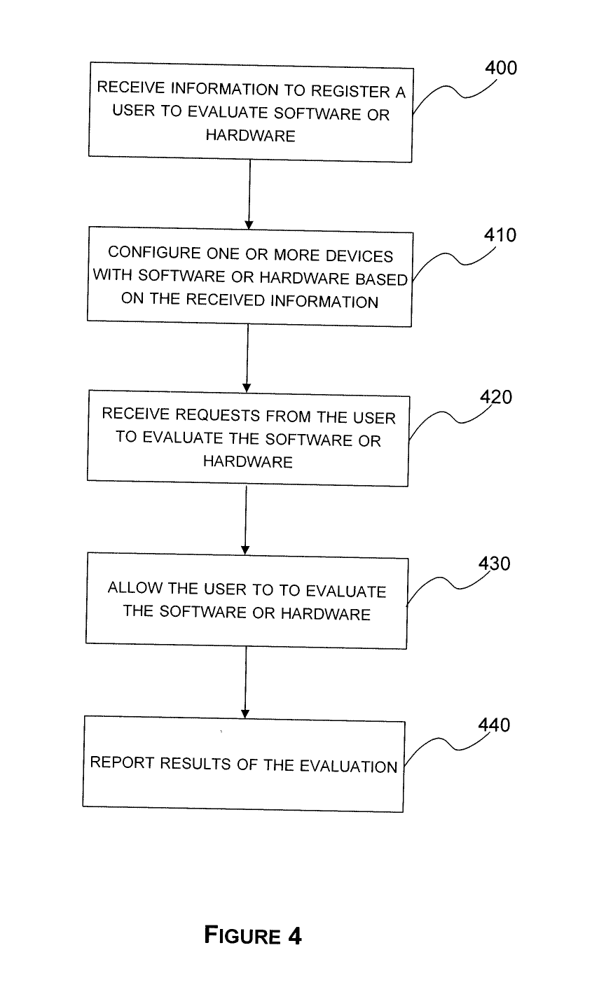

FIG. 4 illustrates additional routines and actions performed by exemplary components of a system for evaluating one or more software and/or hardware solutions. In some embodiments, this routine can be performed by components of evaluation processing device 100, administration device 155, user devices 170A-N, evaluation devices 185A-N, and/or organization administration device 195. Depending on the embodiment, the method of FIG. 4 may include fewer or additional blocks and blocks may be performed in an order that may be different than illustrated.

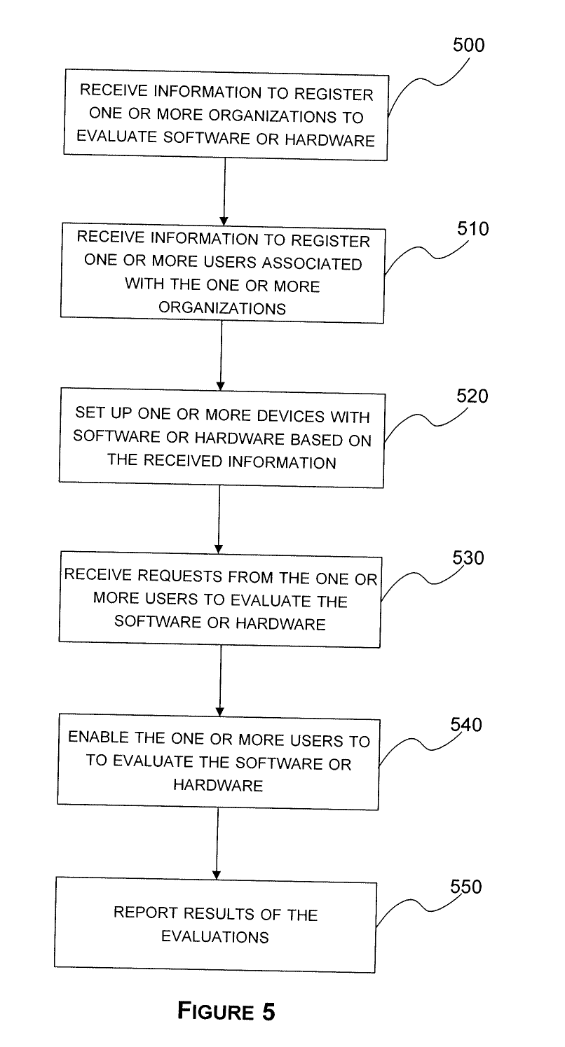

Beginning in block 400, an evaluation processing device 100 or system receives information to register a user or organization to evaluate various software and/or hardware components or configurations. In some embodiments, one or more individual users may be required to separately register or to register as members of a respective organization. For example, in this embodiment, an organization may register its individual users in order to grant them access to the evaluation processing system. This process will be further described with reference to FIG. 5.

Continuing to block 410, the evaluation processing device 100 configures one or more devices with software and/or hardware configuration(s) based on information received from the registered user or organization. The devices may be physical or logical devices. Typically, the information includes the information described with respect to other Figures herein, such as functionality, reliability, and/or performance related information. Moving to block 420, the evaluation processing device 100 may then receive a request from the user to evaluate software and/or hardware configuration(s) orchestrated on evaluation devices. Continuing to block 430, the system allows the user to evaluate software and/or hardware configuration(s) by providing access to the provisioned devices directly over a network, or through an intermediary such as evaluation processing device 100.

Moving to block 440, the results of the evaluation of one or more configurations may then be reported in a graph format, for example. The reports may include hardware or software utilization metrics for a particular configuration, e.g. CPU, memory, storage, power, and/or networking, in order to allow the user(s) and associated organization(s) to evaluate the feasibility of proposed information technology solutions. The data needed to generate the reports can be queried by monitoring the configured devices and/or extracting data from the log files of the configured devices, for example.

FIG. 5 illustrates additional routines and actions performed by exemplary components of a system for evaluating a software and/or hardware solutions in a multi-organization environment. In some embodiments, this routine can be performed by components of evaluation processing device 100, administration device 155, user devices 170A-N, evaluation devices 185A-N, and/or organization administration device 195. Depending on the embodiment, the method of FIG. 5 may include fewer or additional blocks and blocks may be performed in an order that may be different than illustrated.

Beginning in block 500, an evaluation processing device 100 or system may receive information to register one or more organizations to evaluate a potential software and/or hardware solution to their business and/or technical needs, for example. Moving to block 510, the evaluation processing device 100 receives information to register the one or more users associated with the one or more organizations. Continuing to block 520, the evaluation processing device 100 sets up the one or more evaluation devices 185A-N with software and/or hardware based on the received information. For example, the evaluation processing device 100 may provision or orchestrate the evaluation devices 185A-N described with respect to FIGS. 1A-C based on an organization's needs.

Moving to block 530, evaluation processing device 100 can receive requests from the one or more users to evaluate one or more software and/or hardware solutions. The users may be users that belong to a particular organization. In some embodiments, the users may also add their own business or technical requirements, such as performance (e.g. response time, network bandwidth, available memory, etc.), functionality (e.g. Adobe Reader™, Microsoft Visio™ etc.), reliability (e.g. up time), etc. Continuing to block 540, the system enables the one or more users to evaluate a particular configuration of software and/or hardware on the evaluation devices configured for their particular needs and/or cross-compare different configurations. Moving to block 550, the results of the evaluation may then be reported using hardware or software utilization metrics for each of the particular configurations evaluated by the one or more users of the organizations.

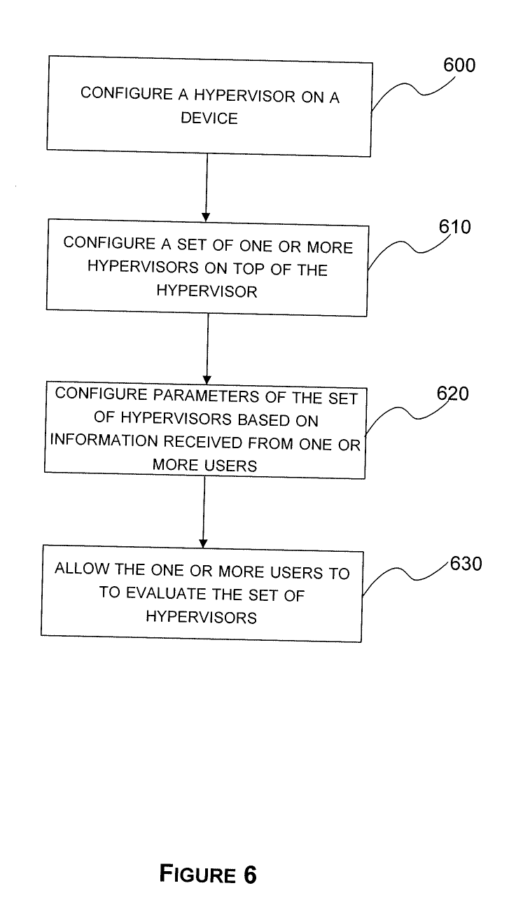

FIG. 6 illustrates routines and actions performed by exemplary components of the devices of FIGS. 1A-C to configure one or more evaluation devices. The exemplary routines can be stored as a process accessible by setup engine 145, evaluation processing engine 130, evaluation device interfaces 190A-N or other components of evaluation processing device 100, administration device 155, or evaluation devices 185A-N. Depending on the embodiment, some of the blocks described below can be removed, others may be added, and the sequence of the blocks may be different.

Beginning in block 600, a hypervisor is configured or installed on a device, such as an evaluation device, or a physical or logical device. The hypervisor can be any computer software and/or hardware platform virtualization software that allows operating systems to run a computing device concurrently, such as a type 1 (bare-metal) or type 2 (hosted) hypervisor. Moving to block 610, a set of one or more hypervisors may further be configured or installed, such that the set of one or more hypervisors may reside on top of the first hypervisor as a second layer of hypervisors. In exemplary embodiments, the second layer of hypervisors can take the place of operating systems and run concurrently on the first hypervisor.

Continuing to block 620, parameters of the set of hypervisors may be configured or provisioned based on information received from one or more users. For example, such information may include a configuration that may correspond to one or more computer software and/or hardware products to evaluate, including brokers, profile managers, application virtualization platforms, or other configuration information described with respect to the other Figures herein. Moving to block 630, one or more users of the evaluation device can then evaluate the set of hypervisors and/or a particular configuration for proof of concept by accessing an evaluation processing device, for example. Thus the provisioned evaluation device can advantageously allow multiple users to evaluate a solution to their information technology needs (e.g. hardware and software needs, performance, reliability, etc.) in an isolated environment. For example when a different user performs an evaluation of a proof of concept and compromises one or more hypervisors in the second layer of hypervisors, the other hypervisors in the second layer and user configurations residing one those other hypervisors remain substantially unaffected.

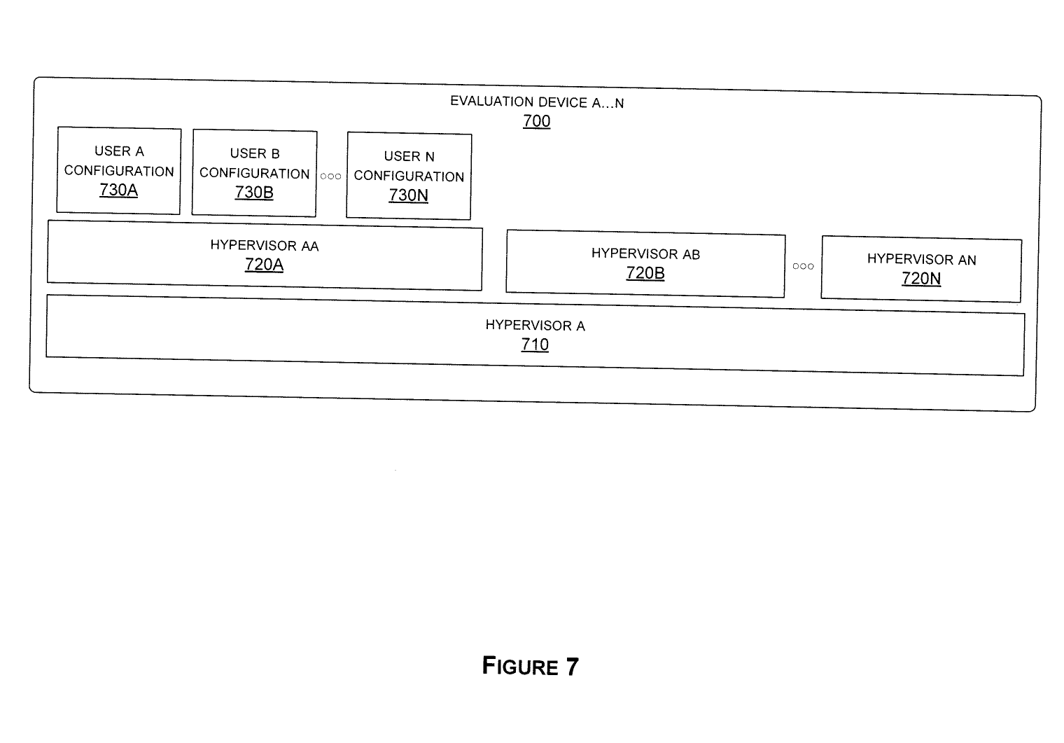

FIG. 7 illustrates an exemplary configuration of an evaluation device set up by exemplary components of an evaluation processing device. As shown, evaluation devices 700A-N may each include a first layer that includes at least one hypervisor 710A-N. As further shown, hypervisor 710A may include a second layer of one or more hypervisors 720A-N. The second layer of hypervisors 720A-N may each include one or more user configurations 730A-N as described herein to generally allow one or more associated users to evaluate one or more hardware and/or software configurations for their feasibility or suitability for a client's technology needs.

Advantageously, the use of multiple layers of hypervisors allows evaluation devices 700A-N to provide sandboxing and/or additional security and isolation in any virtualized system, including those that provide a hosted proof of concept of hardware and/or software solutions. For example, when each of the second layer of hypervisors 720A-N is configured for a different one of the plurality of users or user configurations 730A-N, isolation may be achieved that allows a configuration of one user to remain relatively unaffected by the other user's configuration in the event that one of the second layer of hypervisors 720A-N faces issues generally related to performance, reliability, functionality, and the like.

It will be apparent to those skilled in the art that various modifications and variations can be made in the present disclosure without departing from the spirit or scope of the disclosure. Thus, it is intended that the present disclosure cover any modifications and variations within the scope of the appended claims and their equivalents.

What is claimed is:

1. An evaluation processing device comprising:
a computer memory configured to store configuration information related to one or more evaluation devices that allow one or more computer software products to be evaluated; and
a processor configured to compare a request to evaluate the one or more computer software products from a user with the configuration information, establish a connection to the one or more evaluation devices using a network interface based on the comparison, and allow the user to evaluate the one or more computer software products over the connection.

2. The evaluation processing device of claim 1, wherein the network interface is configured to receive a set of needs from the user, and the processor is further configured to determine suitable software products for the user based on the set of needs.

3. The evaluation processing device of claim 2, wherein the processor is further configured to provision the one or more evaluation devices with the suitable software products.

4. The evaluation processing device of claim 1, wherein the memory is further configured to store a set of rules for possible configurations of the one or more computer software products, and the processor is configured to set up the one or more evaluation devices based on the set of rules.

5. The evaluation processing device of claim 1, wherein the configuration information comprises software product configurations for the user and a mapping of the software product configurations to the one or more evaluation devices.

6. The evaluation processing device of claim 1, wherein the processor is configured to allow the user to evaluate the one or more computer software products by using an application programming interface provided by the one or more evaluation devices.

7. The evaluation processing device of claim 1, wherein the processor is configured to allow the user to evaluate the one or more computer software products by sending commands understood by the one or more evaluation devices over the connection.

8. The evaluation processing device of claim 1, wherein the one or more computer software products comprises virtualization software.

9. The evaluation processing device of claim 8, wherein the virtualization software includes a virtualization solution scenario.

10. The evaluation processing device of claim 1, wherein the network interface further includes physical assets being configured based on a specific environment.

11. The evaluation processing device of claim 1, wherein the one or more computer software products comprises a hypervisor.

12. A computer-implemented method comprising:
receiving information to register an organization to evaluate at least one product;
setting up one or more evaluation devices with the at least one product based on the organization information; and
enabling the organization to evaluate the at least one product on the one or more evaluation devices.

13. The method of claim 12, wherein the organization information comprises a set of requirements for the organization.

14. The method of claim 12, further comprising registering a user associated with the organization.

15. The method of claim 14, further comprising setting up the one or more evaluation devices with the at least one product based on the user information.

16. The method of claim 12, wherein the at least one product comprises computer hardware.

17. The method of claim 12, wherein the at least one product comprises computer software.

18. The method of claim 12, further comprising receiving results of the evaluation of the at least one product from the one or more evaluation devices.

19. The method of claim 18, further comprising generating a report from the results.

20. The method of claim 19, wherein the report comprises information related to performance of the at least one product.

21. The method of claim 19, wherein the report comprises information related to reliability of the at least one product.

22. The method of claim 19, wherein the report comprises information related to functionality of the at least one product.

23. The method of claim 19, wherein the report comprises a cost-benefit analysis of the at least one product.

24. A computer readable medium having stored thereon computer executable components, the medium comprising:
a rules engine configured to group a plurality of products into interoperable sets; and
an evaluation processing engine configured to receive a set of needs of a user, match the needs of the user with the interoperable sets of products, and provision one or more evaluation devices with at least one interoperable set of products based on the matching.

25. The computer readable medium of claim 24, wherein the set of needs of the user are based on one or more responses to questions by the user.

26. The computer readable medium of claim 24, wherein the evaluation processing engine is further configured to provision the one or more evaluation devices based on permissions of the user.

27. The computer readable medium of claim 24, wherein the rules engine groups the plurality of products into interoperable sets based on a set of rules that determine which products are interoperable with one another

28. A computer-implemented method comprising:
installing a first hypervisor on an evaluation device; and
installing a set of one or more hypervisors on top of the first hypervisor in order to allow a plurality of users to evaluate one or more software products.

29. The method of claim 28, wherein each of the set of hypervisors is configured for a different one of the plurality of users.

30. The evaluation processing device of claim 1, wherein the network interface further includes virtual assets being configured based on a specific environment.
